(19) United States
(12) Patent Application Publication
(10) Pub. No.: US 2013/0101915 A1
(43) Pub. Date: Apr. 25, 2013

(54) COMPOSITE SEAL FOR FUEL CELLS, PROCESS OF MANUFACTURE, AND FUEL CELL STACK USING SAME

(71) Applicants: Jean Yamanis, South Glastonbury, CT (US); Sunil G. Warrier, Middletown, CT (US); Sarah Arsenault-Preece, West Brookfield, MA (US); Justin R. Hawkes, Marlborough, CT (US)

(72) Inventors: Jean Yamanis, South Glastonbury, CT (US); Sunil G. Warrier, Middletown, CT (US); Sarah Arsenault-Preece, West Brookfield, MA (US); Justin R. Hawkes, Marlborough, CT (US)

(73) Assignee: UTC POWER CORPORATION, South Windsor, CT (US)

(21) Appl. No.: 13/806,152

(22) PCT Filed: Jun. 25, 2010
(86) PCT No.: PCT/US10/39979

§ 371 Date: Dec. 21, 2012

(51) Int. Cl. H01M 8/02

(52) U.S. Cl. CPC H01M 8/028
USPC 429/453; 429/463; 429/469; 277/628; 156/184

(57) ABSTRACT

A seal is provided for use in a solid oxide fuel cell, wherein the seal is formed of alternating adjacent layers of a fiber tow material and a foil material. A solid oxide fuel cell stack is also disclosed and is formed of repeating cell units, each cell unit having a plurality of fuel cell stack components defining opposed component surfaces, and the seal as described above positioned between the opposed component surfaces. A process is also provided for manufacturing a composite seal for a solid oxide fuel cell, and the process including the steps of: (a) feeding a quantity of spooled fiber tow material through an inert bonding agent to form a coated fiber tow material; (b) winding the coated fiber tow material about a mandrel to form a wound layer of fiber tow material; (c) feeding a quantity of spooled foil material about the wound layer of fiber tow material to form a wound layer of foil material; and (d) repeating steps (a) through (c) until forming a composite seal having desired thickness and width.

### FIELD OF THE DISCLOSURE

The invention relates to fuel cells and, more particularly, to seals for a solid oxide fuel cell stack.

### BACKGROUND OF THE DISCLOSURE

The primary function of seals in a solid oxide fuel cell (SOFC) stack is to prevent mixing of gaseous reactants used in the SOFC stack. In order for the seals to provide the desired function, it is necessary that the seals possess mechanical and chemical stability at high temperatures and moist reducing conditions present within an SOFC stack. In addition, the seals must maintain structural integrity under operation and thermal cycling conditions.

Conventional seals are made of glass or glass-based ceramics where the thermal expansion properties are tailored to match that of the cell and stack components such that the seals maintain structural integrity on thermal cycling. These glasses are typically made of oxides containing silicon, boron, or phosphorous and typically contain additions of alkali metal oxides. Unfortunately, these oxides tend to contaminate the cells and adversely affect the long-term performance of the cells and stack. In addition, these glasses are not chemically stable in moist-reducing environments and do not provide structural integrity for long-term applications.

Prior art seals for SOFC stacks also include the use of gaskets made of discontinuous ceramic fibers mixed with ceramic particles. Such seals leak and result in gas mixing, loss of efficiency and possible degradation of the cell performance.

Based upon the foregoing, it is clear that the need remains for an improved impermeable seal that does not contaminate or otherwise adversely affect cell performance and that is chemically and mechanically stable under long-term operating and thermal cycling conditions.

### SUMMARY OF THE DISCLOSURE

In accordance with this disclosure, a seal is provided for use in a solid oxide fuel cell, wherein the seal is formed of alternating adjacent layers of a fiber tow material and a foil material.

In accordance with another aspect of the disclosure, a solid oxide fuel cell stack is provided and is formed of repeating cell units, each cell unit having a plurality of fuel cell stack components defining opposed component surfaces, and the seal as described above positioned between the opposed component surfaces.

In accordance with another aspect of the present disclosure, a process is provided for manufacturing a composite seal for a solid oxide fuel cell, and the process includes the steps of: (a) feeding a quantity of spooled fiber tow material through an inert bonding agent to form a coated fiber tow material; (b) winding said coated fiber tow material about a mandrel to form a wound layer of fiber tow material; (c) feeding a quantity of spooled foil material about said wound layer of fiber tow material to form a wound layer of foil material; and (d) repeating steps (a) through (c) until forming a composite seal having desired thickness and width.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1A shows a top view of a circular composite seal having alternating layers of ceramic fiber and metal foil according to the present disclosure;

FIG. 1B is an enlarged cross-sectional view of area A-A of FIG. 1A;

FIG. 2A shows a rectangular composite seal having alternating layers of ceramic fiber and metal foil disposed between a pair of containment barriers;

FIG. 2B is a cross-sectional view of the seal of FIG. 2A taken along line B-B;

FIG. 3A shows the seal of FIG. 1A mounted within a solid oxide fuel cell stack;

FIG. 3B shows an expanded view of the composite seal of FIG. 3A illustrating the composite seal structure and the typical leak path of fuel flow through a fuel cell unit.

FIG. 3C shows a composite seal of the present disclosure placed between two metal parts, wherein one of the parts has integral containment barriers.

FIG. 4 is a schematic diagram of a process for making a rectangular composite seal of the present disclosure; and

FIG. 5 shows a cross-sectional view of the seal being wound about the mandrel of FIG. 4.

Like reference numbers and designations in the various drawings indicate like elements.

### DETAILED DESCRIPTION

The disclosure relates to a composite seal for a solid oxide fuel cell (SOFC), to a method for making the seal, and to an SOFC stack containing one or more seals as described herein.

As used herein, the term “ceramic fiber tow material” may be referred to as “fiber tow material” or “fiber tow”.

As used herein, the term “ceramic fiber tow material” includes the term “ceramic fiber roving” wherein a roving is a loose assemblage of fibers without twist.

As used herein, the term “metal foil material” may be referred to as “foil material” or “foil”.

As used herein, the terms “continuous fibers”, “continuous filaments” and “continuous fibers or filaments” means ceramic filaments or fibers with extremely high length to diameter ratios, and such physical properties make these continuous filaments and fibers distinct from chopped filaments or fibers.

As used herein, the term “continuous strand” means a strand in which individual filament lengths approach the strand length.

As used herein, the term “balanced stress” means the load is distributed upon either side of the cell so as not to induce bending stresses within the cell.

As used herein, the term “matching compliance” means a matched displacement on both sides of the cell so that a bending moment or localized stress(es), both of which can lead to fracture of the cell, are not created.

As used herein, the term “pore free” means the foil material is substantially free and, preferably, completely free of interconnected pores.

FIGS. 1A and 1B illustrate an exemplary embodiment of a composite seal 10 of the present invention which is well suited for use in planar solid oxide fuel cells (SOFC). The composite seal in this embodiment is circular and may be manufactured from materials that are stable and non-contaminating both at SOFC operating temperatures and following exposure to such conditions. “Non-contaminating” materials are materials which, when exposed to SOFC operating conditions, do not corrode and/or contaminate the fuel or oxidizer gas streams, and do not poison the SOFC cathode electrode, anode electrode and/or the electrolyte. The materials remain both chemically and structurally stable under SOFC operating conditions.

Referring to FIG. 1B, composite seal 10 may have a multilayer design having alternating layers of a fiber tow material 12 and a foil material 14. Foil material 14 is preferably a substantially flat material arranged between tow material 12 as shown and having edges 66, 68 which extend preferably beyond edges 74, 76 of tow material 12. Thus, edges 66, 68 are spaced from each other and extend along opposite sides of foil 14. In use, the first edge 66 of foil 14 is in contact with one surface between which seal 10 is positioned, this surface having a first coefficient of thermal expansion (CTE). Second edge 68 is in contact with a second surface between which seal 10 is positioned, and this surface can have a second CTE which may be different from the first CTE.

As will be discussed below, edges 66, 68 are preferably in intimate contact, i.e., in contact under some compressive force, with the surfaces against which they are sealing, and this helps to prevent harmful bulk flow of fuel or oxidant stream in undesired directions in the cell during operation.

Generally, the foil material may be pore free or free of interconnected porosity so that it eliminates diffusional flow of the fuel or oxidant gas stream during use of the seal as well. Thus, a suitable foil material preferably has less than 5% porosity, and preferably less than 1% porosity.

The fiber tow material may exhibit deformability and accommodate thermal strains through elastic buckling and plastic deformation. Such physical properties permit the fiber tow material to deform when compressive loads are exerted upon the composite seal via the fuel cell and then “spring back”, that is, recover its shape, once such loads are relieved. The fiber tow material's ability to spring back is directly related to the structure and dimensions of the foil material and the design of the composite seal. The ratio of the foil material thickness to foil material height may be small enough to permit the ceramic portion of the seal 10 to dominate the mechanical response. Typically, the foil material will be provided having a ratio of thickness to height of no more than about 0.1, and this will generally be sufficient to produce elastic buckling of the foil material and permit deformation of the fiber tow material to dominate the mechanical response at an expected sealing load greater than about 1 psi. The thickness of foil material 10 will generally be greater than about 12 micrometers (or 0.0005 inch) and less than about 100 micrometers. The thickness of the fiber tow material 12 is generally greater than 0.15 millimeters and less than about 2 millimeters. This thickness, it should be noted, refers to the thickness of an entire wound layer of fiber tow material, and is also thickness considered when the seal 10 is at a rest condition, that is, when the seal is not under compression within a fuel cell.

Ceramic fiber tow material 12 may include, but is not limited to, continuous alumina (Al₂O₃) filaments wound to form the fiber tow. Other suitable continuous ceramic fiber filaments and tows may be used such as alumina-silica fibers, silica fibers, silicon carbide fibers, zirconia fibers, alumina-zirconia fibers, mullite fibers, yttrium-aluminum-garnet (YAG) fibers and mixtures thereof. For example, a representative ceramic fiber tow material is 3M® Nextel Fibers commercially available from Minnesota, Mining & Manufacturing of Minneapolis, Minn.

Suitable metal foil material 14 includes, but is not limited to, stainless steel foils, nickel-based superalloy foils, noble metal foils, silver foils, noble metal-plated base-metal foils, silver-plated base-metal foils, and combinations of the aforementioned foil materials. Alumina and silver do not react chemically with the solid oxide fuel cell electrodes and electrolyte materials when exposed to SOFC operating conditions and are, thus, considered to be non-contaminating materials. Other pairs of materials, beyond alumina and silver, can be chosen so as to ensure chemical compatibility and, therefore, ensure the absence of contamination sources. In addition, these materials may also permit electronic conductivity from the anode electrode to the anode side frame without sacrificing stack performance.

FIG. 1B illustrates both the fiber tow material 12 and foil material 14 having a near or pseudo-substantially rectangular cross-sectional shape. The cross-sectional shape of the materials 12, 14 and the seal itself may be any geometry, for example, rectangular, square, trapezoidal, triangular, etc., or non-prismatic shape, for example, circular, oval, etc., as required.

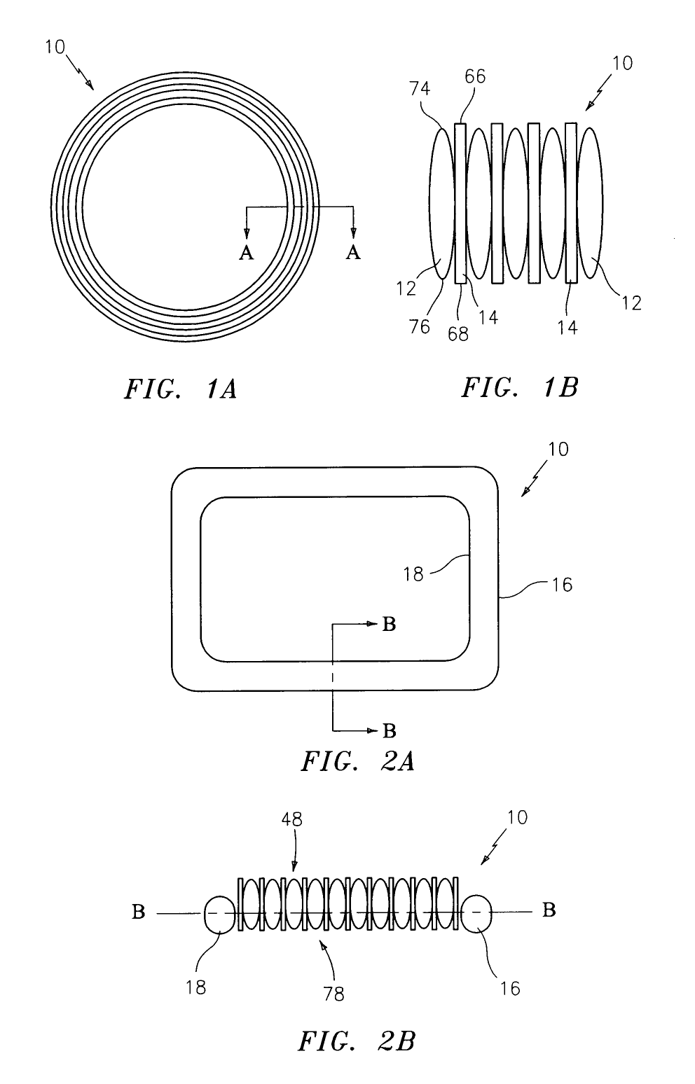

Referring now to FIGS. 2A and 2B, the composite seal 10 may also have at least one containment barrier 16, 18. The containment barriers 16, 18 are designed to prevent the materials 12, 14 of the seal 10 from spreading or creeping, and in turn further reduce and/or prevent gas stream leakage from within or between compartments of the fuel cell.

Containment barriers 16, 18 are preferably positioned at an inner edge and/or an outer edge of composite seal 10, and these barriers prevent lateral spreading of seal 10 in a direction perpendicular to the compressive force applied to seal 10 during use. Preferably, a first containment barrier 16 may be arranged against a radially outer surface of the composite seal 10 and a second containment barrier 18 may be arranged at a radially inner surface of the composite seal 10. The containment barriers 16, 18 may each have a thickness less than the thickness of the composite seal 10. Thus, seal 10 in this embodiment can be considered to have two sealing surfaces 48, 78 on opposed sides, and coincident with edges 66, 68 of foil members 14, and having inner and outer side surfaces extending between sealing surfaces 48, 78 and in this embodiment each defined by a containment barrier 16, 18. It should be noted that the positioning of the containment barriers 16, 18 as described herein refers to these barriers being on radially inner and outer surfaces of the seal. This is most clear, of course, when the seal has a ring shape. Of course, the seal according to the invention can have other shapes as well, but these shapes will all have an inside and an outside edge corresponding to the radially outer and inner edges of the ring seal, and these terms should therefore be understood in context of such non-ring shaped seals.

The containment barriers 16, 18 may also be made from a material that is stable at SOFC operating temperatures and is non-contaminating. Suitable materials for barrier 16, 18 include, but are not limited to, stainless steel, silver, nickel-chromium, iron-chromium, iron-chromium-aluminum alloy, nickel-based alloy or metal wire formed so as to conform to the shape of and compliment the exterior surface and interior surface of composite seal 10. Two particularly preferred materials are stainless steel wires and nickel-based alloy wires. The wire used to form these barriers can have the wire ends joined by welding or mechanical links. Each containment barrier 16, 18 may have a shape that is the same or different from the shape of the materials 12, 14, and a different shape is illustrated in the cross-sectional view taken along lines B-B in FIG. 2B. The barriers 16, 18 may have a circular or rectangular cross section or any other suitable geometry.

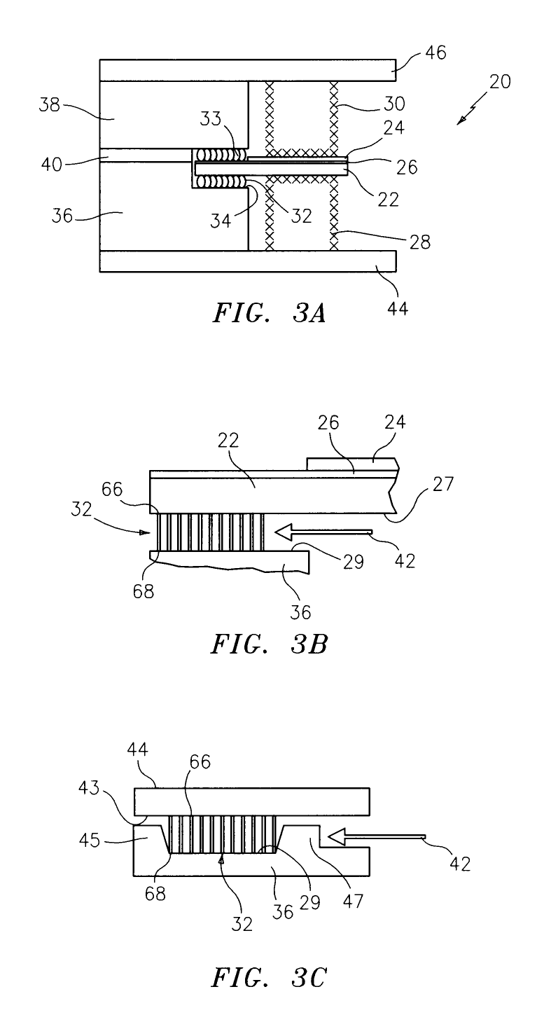

Referring now to FIG. 3A, a partial cross-sectional view of a planar SOFC stack 20 (“SOFC stack 20”) is shown. Generally, a fuel cell stack 20 may be formed of repeating cell units. Each cell unit can be formed from a trilayer structure having an anode electrode 22 and a cathode electrode 24 arranged opposite each other upon the surfaces of a dielectric electrolyte layer 26. The cell trilayer may be disposed in part between an anode side interconnect 28 and a cathode side interconnect 30. Advantageously, one or more seals according to the present disclosure can be included, and FIG. 3A shows an anode side seal 32 and a cathode side seal 33. At least one composite seal, for example anode side seal 32, may be arranged within a groove, for example groove 34 formed within an anode side frame 36. Anode side seal 32 may be arranged between an electrically conducting layer such as anode layer 22 and anode side frame 36. Cathode side seal 33 may be arranged between the electrolyte layer 26 and a cathode side frame 38 and adjacent to an insulating seal 40.

Referring to FIG. 3B, the first edge 66 of the foil material of the anode side seal 32 may contact a first sealing surface 27, i.e. a first exterior surface, of the anode layer 22 and a second edge 68 of the foil material 14 of the anode side seal 32 may contact a second sealing surface 29, i.e. an exterior surface, of the anode side frame 36. The anode side frame 36 may be disposed opposite the cathode side frame 38 with the insulating seal 40 separating the frames 36, 38. The cell unit may be defined and bounded by at least one separator plate 44, 46. At least one separator plate 44 may be arranged adjacent to and connected with the anode side frame 36 and anode side interconnect 28. Further, at least one separator plate 46 may be arranged adjacent to and connected with the cathode side frame 38 and cathode side interconnect 30. Separator plate 44 may be connected to anode side interconnect 28 on one side and to a cathode side interconnect 30 on the other side, and the set of parts 28, 44, and 30 is often referred to as the bipolar plate.

FIGS. 3A and 3B also illustrate how the composite seal and stack in which the seal is positioned is designed to contain the fuel gas stream and reduce and/or eliminate leakage altogether. The periphery of the dielectric electrolyte layer 26 in this embodiment is sandwiched between cathode side seal 33 and anode side seal 32. Preferably, cathode side seal 33 is arranged to contact only the dielectric electrolyte layer 26, and not cathode electrode 24. The anode side and cathode side seals 32, 33 preferably provide a balanced stress to the fuel cell unit, that is, both seals 32, 33 need to have matching compliance. Still referring to FIG. 3B, anode side seal 32 can advantageously be positioned within the fuel cell unit with foil material 14 substantially perpendicular to the fuel flow path represented by the arrow 42 in FIG. 3B. Due to the numerous foil material layers within the anode side seal 32, multiple pore-free barriers are present to reduce and/or substantially prevent leakage rates to no more than about two percent (2%), and preferably no more than about one percent (1%) under expected sealing loads as known to one of ordinary skill in the art. Preferably, the anode side seal 32 is capable of meeting the aforementioned defined leakage rates under a compressive load of about 1 psi to about 100 psi. For example, at least one suitable material may be 1500 Denier Nextel 610 fibers coated with polyethylene glycol (PEG) (Aldrich 20245-2).

Referring to FIG. 3C an embodiment is shown where seal 32 is positioned between two metal parts, one of which may be separator plate 44 and the other being part 36. These two metal parts may be a fragment of a conduit for the containment and distribution of a gaseous stream, i.e., the conduit is of a gas manifold structure. In this embodiment at least one of the metal parts in FIG. 3C must have a dielectric sealing surface, i.e., surface 43 on separator plate 44 or surface 29 on part 36, to provide electrical isolation. This design also has built in barriers 45, 47 for seal containment. Barriers 45, 47 may be tilted by a few degrees relative to the normal to surface 29 of part 45 to facilitate the placement of seal 32. The overall seal geometry for this concept may be rectangular, circular or any other shape.

In accordance with another aspect of the invention, and returning to FIG. 3A, a solid oxide fuel cell stack can be formed of repeating units 20. Each repeat unit 20 generally includes a cell frame 36, 38, a solid oxide fuel cell (components 22, 24, 26), and a separator plate 44, 46. As discussed earlier, the bipolar plate includes a separator plate; an anode side interconnect 28 and a cathode side interconnect 30. These components are assembled into a cassette structure having a hermetically sealed fuel gas stream space wherein fuel gas stream distribution between repeat units is achieved. The fuel side seals are preferably designed as described above and include alternating layers of fiber tow material and foil material.

The seal materials are stable and non-contaminating, i.e., they do not react with the cell electrolyte or electrodes and they do not emit any chemical materials that react with the cell electrolyte or electrodes under SOFC operating conditions. The SOFC operating conditions, in general, are temperatures in the range of 500° C. to 1000° C., pressures in the range of 101.3 kPa to 1013 kPa or even higher, and in contact with gaseous streams of the anode side of hydrogen, CO, CH₄, CO₂, superheated steam and maybe other hydrocarbons, and on the cathode side air, or air with depleted oxygen and some water moisture, depending on the prevailing ambient conditions.

According to this disclosure, the composite seal design can be positioned between component surfaces without being bonded to the ceramic SOFC or metal parts, and this allows some sliding during thermal cycling and therefore provides the stack with robustness under thermal cycling.

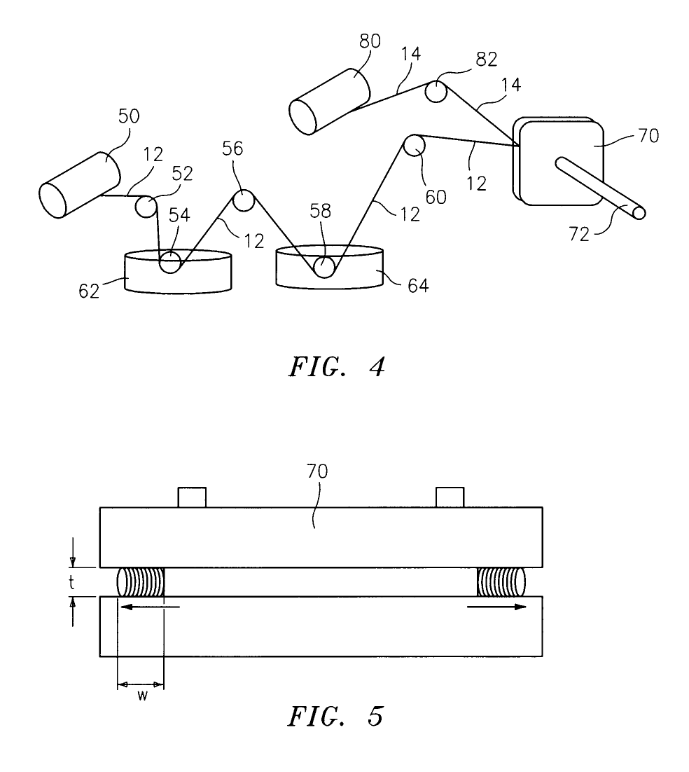

Referring now to FIGS. 4-5, the composite seal of the present invention may be manufactured using any one of a number of processes. For example, FIG. 4 illustrates one preferred process for manufacturing the composite seal described herein. As shown, this process involves winding the fiber tow material 12 from a spool 50 through a system of pulleys and rollers 52, 54, 56, 58, 60 to a mandrel 70. As described herein, the fiber tow material 12 may in one embodiment be made from a ceramic fiber such as 3M® Nextel fibers. The ceramic fiber tow material may be fed from spool 50 along roller 52 into a first pool 62 along roller 54. The pool 62 may contain a solvent capable of removing any residual coating generally found on ceramic fiber tow materials, for example as placed by the original manufacturer. One example of a suitable solvent is isopropanol may be utilized to remove such residual coatings. The fiber tow material 12 may then be fed along roller 56 into a second pool 64 along roller 58. The second pool 64 may contain an inert bonding or adhesive agent to provide handleability of the resultant seal. For example, a suitable inert bonding agent such as polyethylene glycol (PEG) may be utilized. As known to one of ordinary skill in the art, PEG is inert with regard to the ceramic and metal materials used herein and will burn off cleanly during an initial SOFC startup. After being coated with the inert bonding agent, the coated fiber tow material 12 may be fed along roller 60 and wound about a mandrel 70 which can be rotated itself about a shaft 72.

The fiber tow material 12 may be wound about the mandrel 70 until the desired layer thickness is achieved and then set to dry and take shape. The desired shape of the resultant seal will exhibit a slight radius on the sides to keep uniform tension while winding and manufacture a symmetrical seal (See FIG. 5).

After forming a layer of fiber tow material 12 about the mandrel 70, foil material 14 may be fed from a spool 80 along a roller 82 and wound about mandrel 70 rotating about shaft 72. The metal foil may be wound about the mandrel 70 until the desired thickness of that foil layer is achieved and then set to dry and take shape.

These steps are repeated to form alternating layers of the fiber tow material 12 and foil material 14 around the mandrel 70. The desired thickness t of the resultant seal may be controlled by the design of the mandrel (See FIG. 5), for example by setting the size of the gap between which the seal is formed, while the width w of the seal may be controlled by the number of wraps and width of each wrap of fiber tow material and/or foil material. Throughout the process, the materials 12, 14 may be fed through the rollers at a rate of about 1 RPM (revolutions per minute) to about 10 RPM. The resultant composite seal possesses a thickness and a width sufficient to impart a leakage rate of no more than about two percent when combined with a solid oxide fuel cell and a side frame.

More generally, after forming a first layer of fiber tow material 12 about the mandrel 70, foil material 14 may be fed from a spool 80 along a roller 82 and fiber tow material 12 may be fed from spool 50 and the two materials can be simultaneously wound about mandrel 70 rotating about shaft 72 forming alternating layers of the fiber tow and foil materials. The fiber tow 12 and metal foil 14 may be wound about the mandrel 70 until the desired thickness of the composite seal is wound on the mandrel, at which point the feeding of the foil material is interrupted while the fiber tow material is allowed to wrap around mandrel 70 for a plurality of layers, so that the fiber tow material 12 forms the first and last layers of the composite seal. In another embodiment, the metal foil material 14 forms the first and last layers of the composite seal. After the wrapping operation is terminated having achieved the desired width of the composite seal, the composite seal is allowed time to dry and take shape.

After removing the resulting composite seal from the mandrel 70, one or more containment barriers may be applied against to the composite seal. These barriers can be applied to radially inner or outer edges of the seal. The containment barriers may be applied using any one of a number of techniques known to one of ordinary skill in the art.

Alternatively, the containment barrier(s) may be applied during formation of the composite seal. A first quantity of containment barrier material may be wound upon the spool to form the first or radially inner containment barrier prior to simultaneously winding of the fiber tow material and foil material. After completing the winding step, a second quantity of containment barrier material may be wound upon the radially outer edge of the seal wound upon the spool.

The exemplary composite seal described herein provides numerous advantages over prior art seals. First, the combination of, for example, continuous alumina fiber tows and silver foil as the materials for the composite seal offer complimentary properties. The alumina fiber tows offer compliance and spring back properties, while the silver foil offers pore-free barriers limiting both bulk and diffusional flow. These complimentary properties facilitate the seal's ability to reduce the compressive load on the fuel cell unit, and the entire SOFC stack, thereby improving each fuel cell's durability. Secondly, these properties also permit the metal foils to easily deform and accommodate thermal strains through elastic buckling and plastic deformation during assembly, thermal cycling or steady state operation. Thirdly, the exemplary composite seal is generally more tolerant to thermal cycling and thermal shock loads than conventional glass seals presently found in SOFC stack construction.

One or more embodiments of the present invention have been described. Nevertheless, it will be understood that various modifications may be made without departing from the spirit and scope of the invention. Accordingly, other embodiments are within the scope of the following claims.

What is claimed is:

1. A seal for a solid oxide fuel cell, comprising alternating adjacent layers of a fiber tow material and a foil material.

2. The seal of claim 1, wherein the seal has opposed sealing surfaces for contact between fuel cell components, and wherein the sealing surfaces are defined by edges of the foil material and the fiber tow material.

3. The seal of claim 1, wherein the fiber tow material comprises a continuous ceramic fiber tow.

4. The seal of claim 3, wherein the continuous ceramic fiber tow material comprises at least one of the following continuous fibers: alumina fibers, alumina-silica fibers, silica fibers, silicon carbide fibers, zirconia fibers, alumina-zirconia fibers, mullite fibers, yttrium-aluminum-garnet fibers, and combinations thereof.

5. The seal of claim 1, wherein the fiber tow material comprises continuous alumina-silica fibers.

6. The seal of claim 1, wherein the fiber tow material comprises continuous alumina fibers.

7. The seal of claim 1, wherein the foil material comprises at least one of the following metals: stainless steel foils, nickel-based superalloy foils, noble metal foils, silver foils, noble metal-plated base-metal foils, silver-plated base-metal foils, and combinations thereof.

8. The seal of claim 1, wherein the foil material is a noble metal alloy.

9. The seal of claim 1, wherein the foil material is a silver foil or a silver-plated base-metal foil.

10. The seal of claim 1, further comprising a containment barrier around a radially outer edge of the seal.

11. The seal of claim 10, further comprising a further containment barrier around a radially inner edge of the seal.

12. The seal of claim 10, wherein the at least one containment barrier comprises silver alloy wire.

13. The seal of claim 10, wherein the at least one containment barrier comprises stainless steel wire.

14. The seal of claim 10, wherein the at least one containment barrier comprises nickel-based alloy wire.

15. A solid oxide fuel cell stack formed of:
repeating cell units, each cell unit comprising a plurality of fuel cell stack components defining opposed component surfaces, and the seal of claim 1 positioned between the opposed component surfaces.

16. The solid oxide fuel cell stack of claim 15, wherein the foil material has a first edge in contact with one of the opposed component surfaces, and a second edge in contact with the other of the opposed component surfaces.

17. The solid oxide fuel cell stack of claim 15, wherein the plurality of fuel cell stack components comprises:
a solid oxide fuel cell having an anode side and a cathode side;
an anode side frame;
a cathode side frame; and
a bipolar plate including an anode side interconnect adjacent to the anode side frame and a cathode side interconnect adjacent to the cathode side frame of an adjacent repeating fuel cell unit.

18. The solid oxide fuel cell of claim 17, wherein the solid oxide fuel cell comprises a dielectric layer, and wherein the opposed component surfaces are the dielectric layer and the cathode side frame.

19. The solid oxide fuel cell stack of claim 18, further comprising an additional seal according to claim 1 positioned between the dielectric layer and the cathode side frame.

20. The solid oxide fuel cell stack of claim 18, wherein the anode side frame has a groove for receiving the seal.

21. The solid oxide fuel cell stack of claim 18, further comprising containment walls on at least one of the opposed component surfaces for defining a space to receive the seal.

22. The solid oxide fuel cell stack of claim 21, wherein the containment walls are on the anode side frame.

23. The solid oxide fuel cell of claim 17, wherein the solid oxide fuel cell comprises an electrically conducting layer, and wherein the opposed component surfaces are the electrically conducting layer and the anode side frame.

24. The solid oxide fuel cell stack of claim 23, further comprising an additional seal according to claim 1 positioned between the dielectric layer and the cathode side frame.

25. A process for manufacturing a composite seal for a solid oxide fuel cell, comprising the steps of:
(a) feeding a quantity of spooled fiber tow material through an inert bonding agent to form a coated fiber tow material;
(b) winding said coated fiber tow material about a mandrel to form a wound layer of fiber tow material;
(c) feeding a quantity of spooled foil material about said wound layer of fiber tow material to form a wound layer of foil material; and
(d) repeating steps (a) through (c) until forming a composite seal having desired thickness and width.

26. The process of claim 25, further comprising the steps of:
removing said composite seal from said mandrel; and
applying a first containment barrier to a radially outer edge of the seal.

27. The process of claim 26, further comprising applying a second containment barrier to a radially inner edge of the seal.

28. The process of claim 25, wherein steps (b) and (c) are carried out simultaneously.
